(19) United States
(12) Patent Application Publication
(10) Pub. No.: US 2003/0032442 A1
(43) Pub. Date: Feb. 13, 2003

(54) Shock absorbing device on casings

(76) Inventor: Chun-Fu Kuo, Taichung Hsieh (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 09/923,856

(22) Filed: Aug. 7, 2001

(51) Int. Cl. H04B 1/38

(52) U.S. Cl. 455/550; 455/90

(57) ABSTRACT

A casing has a gel layer attached to an outside thereof and a surface layer is attached to the gel layer. The surface layer is made of non-sticky and soft material. The shape of the casing will not be changed because the gel layer and the surface layer are a thin layer which does not change the shape of the casing.

### FIELD OF THE INVENTION

The present invention relates to a shock absorbing device on a casing of a cellular phones or other sophisticate products such that the device absorbs shocks to protect the parts in the casing.

### BACKGROUND OF THE INVENTION

Some sophisticate products such as cellular phones or notebook computers have expensive parts in the casing and these parts should be strictly protected from impacts because the connection between parts are so tiny and could be broken when receiving an impact. That is the reason why the manufacturers recommend the customers to put the products in a glove. However, the glove for receiving the product therein so that people cannot see the products. Most of the users who want show their cellular phones which usually have unique shapes and decorations so that it is important to develop a casing of the product that has anti-shock feature while the shape of the casing is maintained.

### SUMMARY OF THE INVENTION

In accordance with one aspect of the present invention, there is provided a casing that has a gel layer attached on an outside of the casing and a surface layer is attached on the gel layer.

The primary object of the present invention is to provide a shock absorbing layer attached on the casing so as that the parts in the casing can be properly protected from impacts.

The present invention will become more obvious from the following description when taken in connection with the accompanying drawings which show, for purposes of illustration only, preferred embodiments in accordance with the present invention.

### BRIEF DESCRIPTION OF THE DRAWINGS

FIG. 1 is a perspective view to show a conventional casing of a cellular phone;

FIG. 2 is an end cross sectional view to show the two parts composing the conventional casing as shown in FIG. 1;

FIG. 3 is side cross sectional view to show the two parts composing the conventional casing as shown in FIG. 1;

FIG. 4 is side cross sectional view to show the casing having a shock absorbing layer of the present invention;

FIG. 5 is an enlarged view to show the shock absorbing layer of the present invention and the casing;

FIG. 6 is an illustrative view to show the work station for attaching the shock absorbing layer on the casing;

FIG. 7 shows that molds are engaged with the first part of the casing and the material of the shock absorbing layer is not yet poured in the molds;

FIG. 8 shows that the material of the shock absorbing layer is poured in the molds and attached on the first part of the casing;

FIG. 9 is a cross sectional view to show the first part of the casing is attached with the shock absorbing layer;

FIG. 10 is an enlarged view to show the shock absorbing layer on the first part of the casing;

FIG. 11 shows that molds are engaged with the second part of the casing and the material of the shock absorbing layer is not yet poured in the molds;

FIG. 12 shows that the material of the shock absorbing layer is poured in the molds and attached on the second part of the casing;

FIG. 13 is a cross sectional view to show the second part of the casing is attached with the shock absorbing layer;

FIG. 14 is an enlarged view to show the shock absorbing layer on the second part of the casing;

FIG. 15 shows the shock absorbing layer is attached on a PDA;

FIG. 16 is a cross sectional view to show the PDA is attached with the shock absorbing layer, and FIG. 17 is an enlarged view to show the shock absorbing layer on the PDA.

### DETAILED DESCRIPTION OF THE PREFERRED EMBODIMENTS

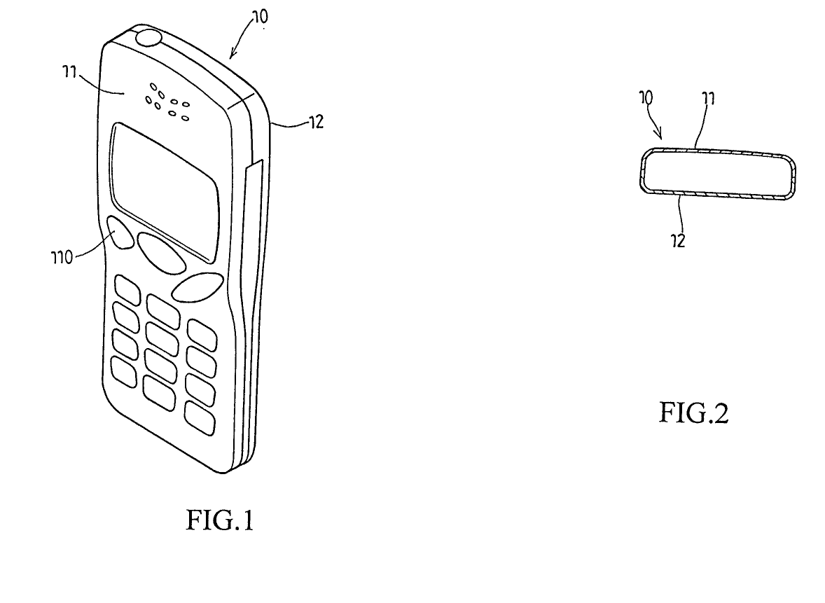

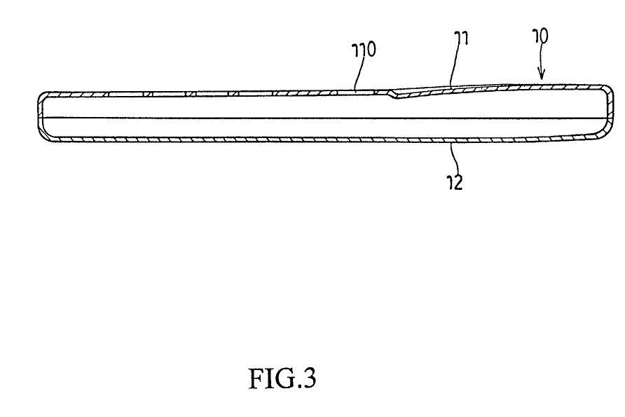

Referring to FIGS. 1 to 3, the conventional casing 10 of a cellular phone is composed of a first part 11 and a second part 12 which is matched with the first part 11 by way of snapping or screws. The first part 11 has apertures 110 defined therethrough for receiving buttons (not shown) inserted therein.

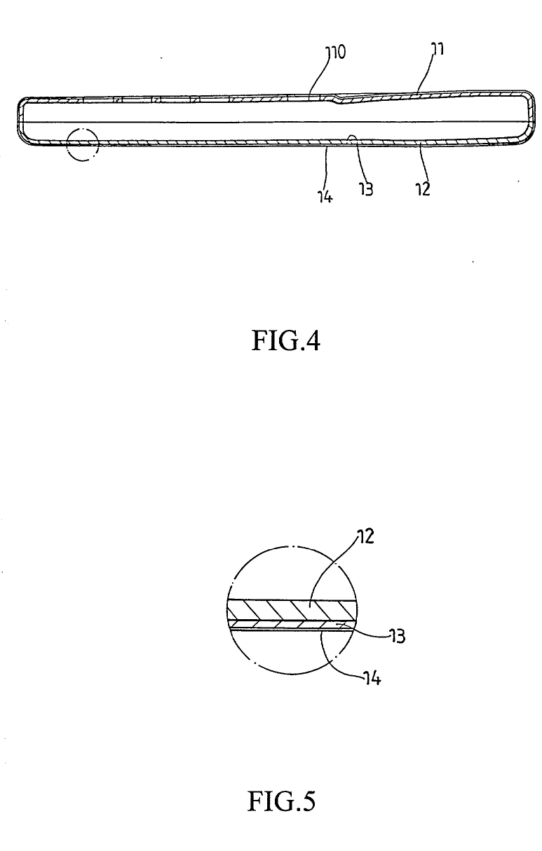

Referring to FIGS. 4 and 5, the shock absorbing layer of the present invention comprises a gel layer 13 and a surface layer 14 attached on the gel layer 13. The gel layer 13 is made of polyesters or silicon gels mixed with setting agent so that the gel layer 13 is resilient and deformable. The surface layer 14 is made from soft and non-sticky material so that the users feel comfortable when holding the shock absorbing layer. The shock absorbing layer on the first part 11 and/or the second part 12 can be spread at plural positions on the first part 11 and/or the second part 12, or the first part 11 and/or the second part 12 are coated with the shock absorbing layer. The shock absorbing layer is a thin layer so that it will not change the shape of the casing. The shock absorbing layer can also be attached on the periphery of the casing.

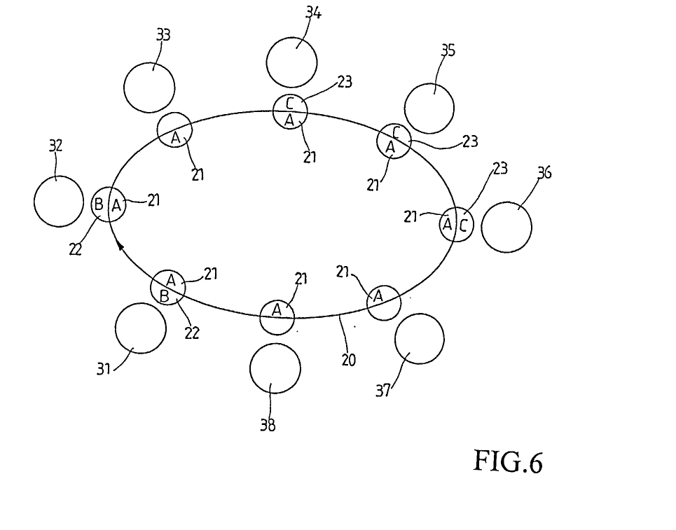

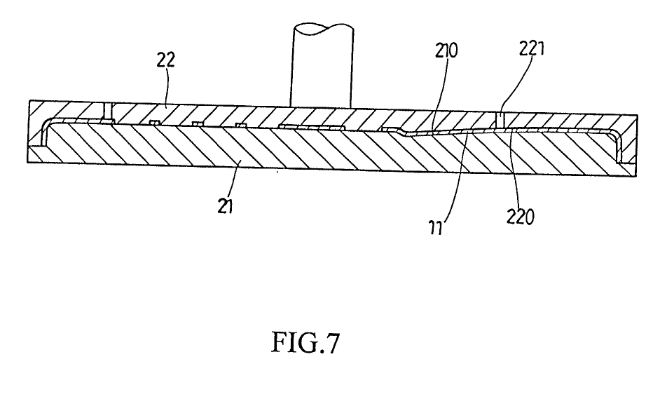

Referring to FIG. 6, the shock absorbing layer is attached on the casing in the operation station which includes a transfer belt 20 arranged as a circle. There are mold-A 21 which can be matched with or swung away from a mold-B 22 and a mold-C 23. There are a first matching area 31 for matching the mold-A 21 and the mold-B 22, an injection area 32, mold-B 22 swinging area 33, a second matching area 34 for matching the mold-A 21 and the mold-C 23, minor-injection area 35, vacuum bubbles removing area 36, statistic electricity coating area 37 and final product area 38 arranged along the belt 20. As shown in FIGS. 6 and 7, in the first matching area 31, the mold-A 21 and the mold-B have two respective cavities 210, 220 whose inner periphery are the shape of the first part 11. The material is injected in the cavities 210, 220 via the passage 221 in the mold-B 22 at the injection area 32 so as to obtain the first part 11.

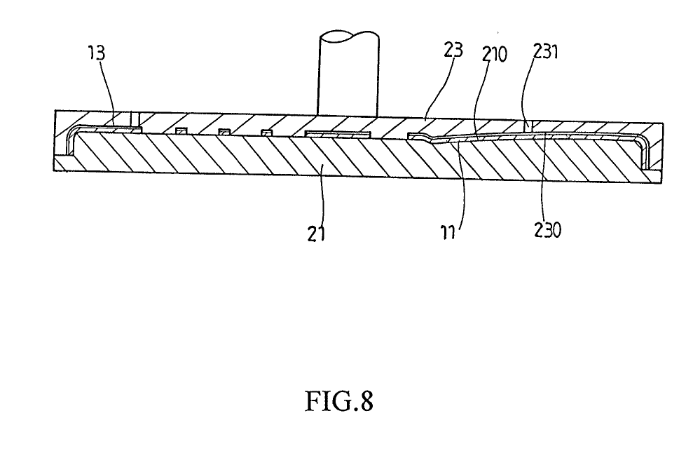

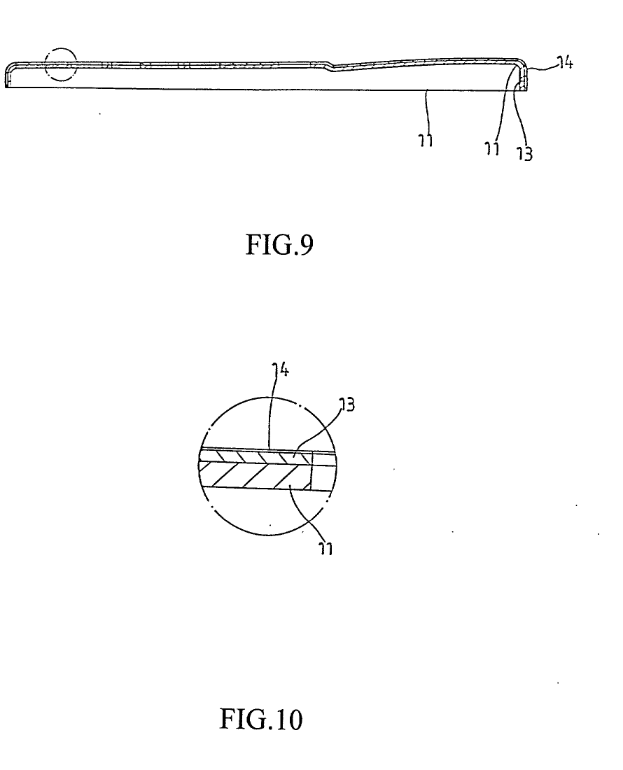

The mold-B 22 is separated from the mold-A 21 at the mold-B 22 swinging area 33. The mold-A 21 and the first part 11 are transferred to the second matching area 34 for matching the mold-A 21 and the mold-C 23. The mold-C 23 is coated with the surface layer 14 in its inner periphery and then matched with the mold-A 21 as shown in FIG. 8. The mold-C 23 is matched with the first part 11 and a space is defined between a cavity 230 and the first part 11 so that the material is injected in the space at the minor-injection area 35. Bubbles in the material mixed with polyesters or silicon gels mixed and setting agent can be removed at vacuum bubbles removing area 36 to completely mix the two types of materials. The mixed material is the gel layer 13 which is resilient and deformable so as to absorb shocks. The surface layer 14 in the mold-C 23 is then attached on the gel layer 13 as shown in FIGS. 9 and 10. After the gel layer 13 is obtained, the mold-A 21 and the mold-C 23 are then separated, and the mold-A 21 sends the first part 11 with the gel layer 13 and the surface layer 14 to the statistic electricity coating area 37 to have a protection layer on the surface layer 14. The product is then pick out from the molds in the final product area 38. The arrangement of the mold-A 21, mold-B 22 and mold-C 23 can be adjusted to meet requirements to simplify the processes of manufacturing.

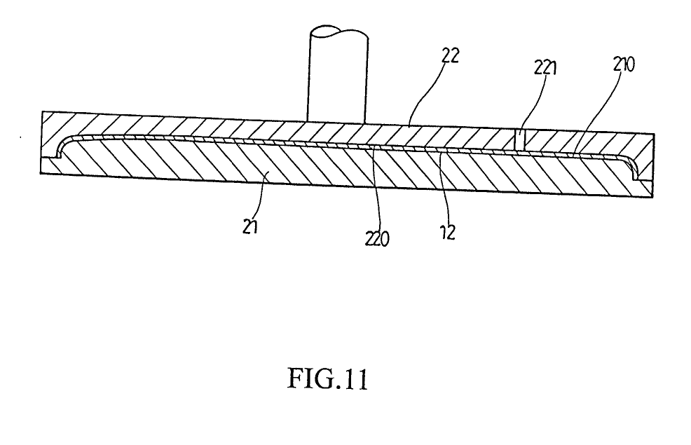

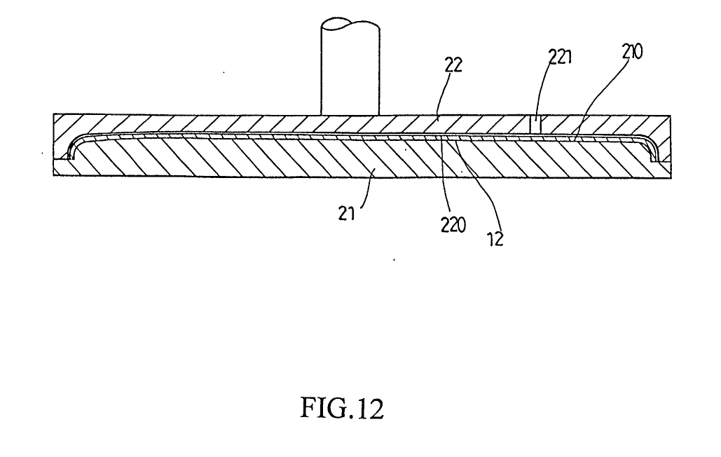

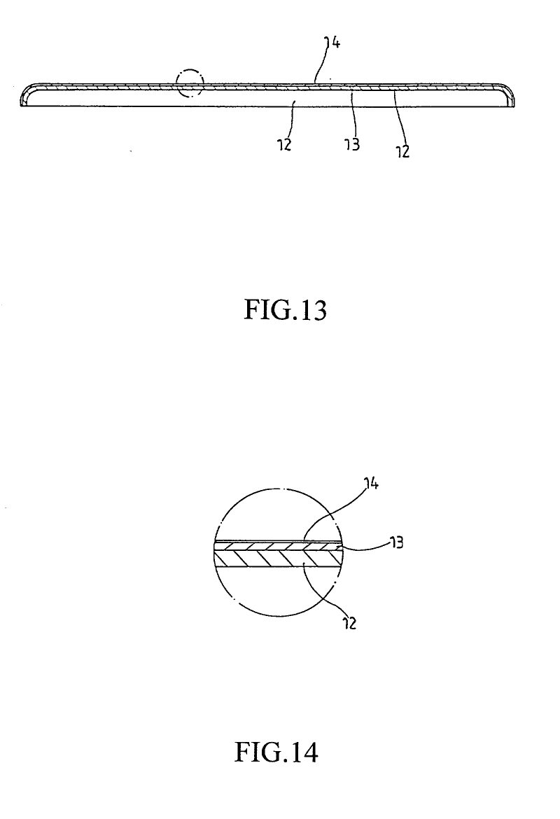

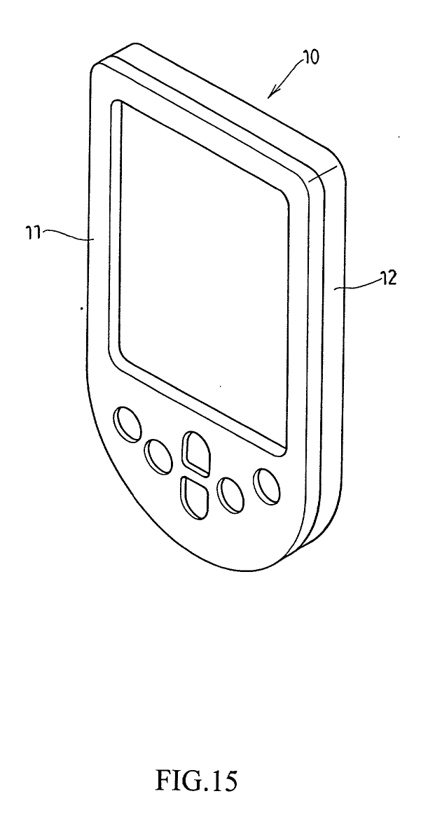

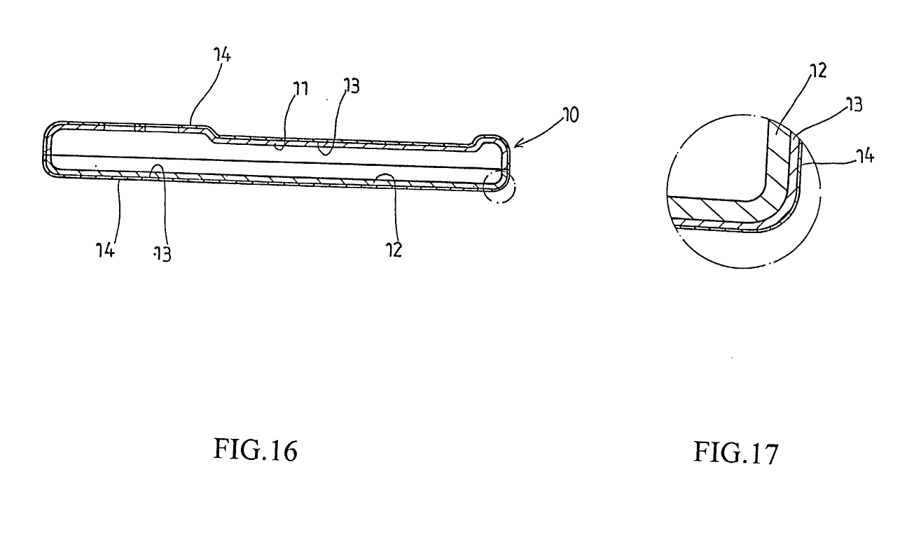

Similarly, referring to FIGS. 11, 12, 13 and 14 and using the processes described above, the second part 12 may have the gel layer 13 and the surface layer 14. FIGS. 15, 16 and 17 show that the shock absorbing layer can be used on a PDA.

While we have shown and described the embodiment in accordance with the present invention, it should be clear to those skilled in the art that further embodiments may be made without departing from the scope of the present invention.

What is claimed is:

1. A casing having shock absorbing device attached thereto, said casing comprising a first part and a second part which is matched with said first part, a gel layer adhered on said casing and a surface layer attached on said gel layer.
